(19) United States
(12) Patent Application Publication
(10) Pub. No.: US 2026/0214282 A1
(43) Pub. Date: Jul. 23, 2026

(54) METHODS AND SYSTEMS FOR PROVIDING PRODUCT INFORMATION

(71) Applicant: Comcast Cable Communications, LLC, Philadelphia, PA (US)

(72) Inventors: Tianchen Wang, Falls Church, VA (US); Md Mahmudul Hasan, Philadelphia, PA (US); Ehsan Younessian, Philadelphia, PA (US); Adhham Zaatri, Philadelphia, PA (US); Eleftherios Soulas, Philadelphia, PA (US)

(21) Appl. No.: 19/032,981

(22) Filed: Jan. 21, 2025

(51) Int. Cl. H04N 21/234; G06Q 30/0251; G06Q 30/0601

(52) U.S. Cl. CPC H04N 21/23418; G06Q 30/0251; G06Q 30/0623; H04N 21/23424

(57) ABSTRACT

Methods, apparatuses, and systems are described for providing product information associated with objects that appear in a content item. A user may request a content item to be output at the user's device and one or more objects that are output in the content item may be identified. Based on the identified one or more objects, one or more products that correspond to the one or more objects may be filtered. In addition, one or more segments of the content item may be identified as segments for displaying product information of the one or more products. At least one of the products may be associated with one of the segments and content associated with the product maybe output during the segment.

### BACKGROUND

Content items, such as videos, movies, and television shows, often feature various objects that may be of interest to viewers. These objects can include clothing, accessories, furniture, electronics, and other products used or worn by characters in the content. Viewers frequently desire to obtain information about these objects, such as product details or purchasing options. However, identifying specific objects within content and providing relevant product information in real-time presents significant technical challenges. Existing systems for recognizing objects in video content typically rely on manual tagging or basic image recognition techniques. These approaches are often inaccurate, labor-intensive, or unable to keep pace with the dynamic nature of video content. Additionally, even when objects are successfully identified, determining the optimal time and method to present product information to viewers without disrupting their viewing experience remains problematic. Furthermore, the sheer volume of objects appearing in content items, combined with the vast array of potential corresponding products, creates difficulties in efficiently filtering and prioritizing which product information to display. Presenting too much information or irrelevant options can overwhelm viewers and detract from their enjoyment of the content. There is a need for improved systems and methods that can accurately identify objects in content items, determine relevant product matches, and intelligently present product information to viewers in a seamless and contextually appropriate manner. Such technological advancements could enhance the viewing experience while providing valuable product discovery opportunities.

### SUMMARY

It is to be understood that both the following general description and the following detailed description are exemplary and explanatory only and are not restrictive. Methods, systems, and apparatuses for providing product information associated with objects that appear in a content item are described.

A shoppable moment segment providing product information of one or more products that appear during output of a content item may be displayed to a user during a segment of the content item being output to the user. A user may request a content item to be output at the user's device. One or more objects in the content item may be identified and one or more products that correspond to the one or more objects may be filtered. In addition, one or more segments of the content item may be identified as candidate shoppable moment segments for displaying product information of the one or more products based on content associated with each segment of the one or more segments. At least one product of the one or more products may be associated with one of the segments. Content associated with the at least one product maybe output during the segment.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system environment;

FIG. 2 shows an example process for displaying product information;

FIG. 3 shows a graph of an example product relevance score;

FIG. 4 shows an example of candidate segments for outputting product information;

FIG. 5 shows an example process for identifying a segment to display product information;

FIG. 6 shows an example scenario for displaying product information;

FIG. 7 shows an example product identification process;

FIG. 8A shows an example product identification process;

FIG. 8B shows an example product identification process;

FIG. 9 shows an example frame segmentation and tagging process;

FIG. 10 shows an example process for adding products to a catalog;

FIG. 11 shows a flowchart of an example method;

FIG. 12 shows a flowchart of an example method;

FIG. 13 shows a flowchart of an example method; and

FIG. 14 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

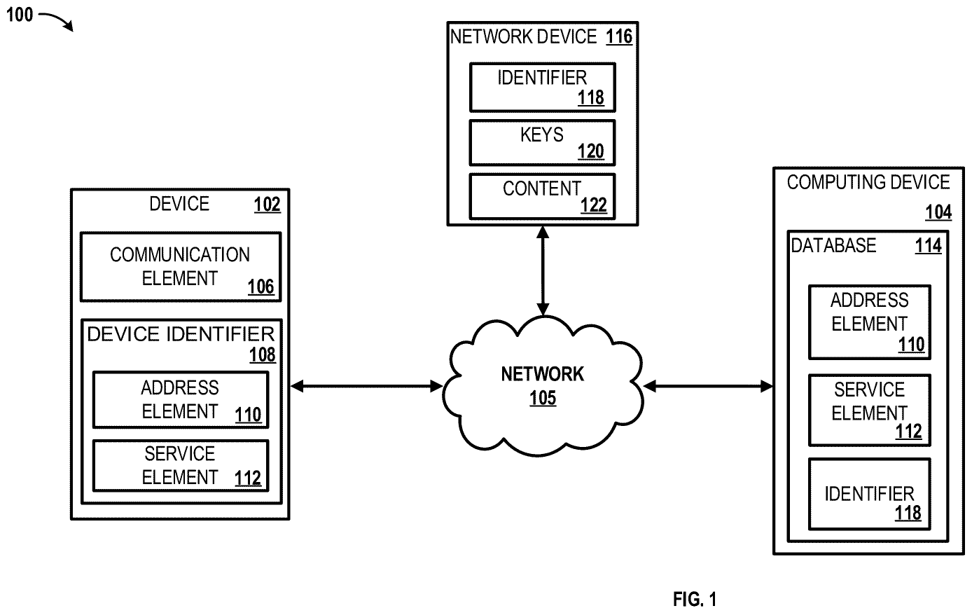

FIG. 1 shows an example system 100 for providing product information associated with objects that appear in a content item. For example, a user may request a content item to be output at the user's device. One or more objects that are output in the content item may be identified and one or more products that correspond to the one or more objects may be filtered. In addition, one or more segments of the content item may be identified for displaying product information of the one or more products based on content associated with each segment of the one or more segments. Content associated with at least one of the products maybe output during the segment. The system 100 may be configured to provide services, such as network-related services, to a device (e.g., device 102). The network and system may comprise a device 102 in communication with a computing device 104, such as a server, via a network 105. The computing device 104 may be disposed locally or remotely relative to the device 102. As an example, the device 102 and the computing device 104 can be in communication via a private and/or public network 105 such as the Internet or a local area network (LAN). Other forms of communications can be used such as wired and wireless telecommunication channels, for example.

The device 102 may comprise an electronic device such as a smart television, a computer, a smartphone, a laptop, a tablet, a set top box, a display device, or other device capable of communicating with the computing device 104.

The device 102 may comprise a communication element 106 for providing an interface to a user to interact with the device 102 and/or the computing device 104. The communication element 106 can be any interface for presenting and/or receiving information to/from the user, such as user feedback. An example interface may be a communication interface such as a web browser (e.g., Internet Explorer®, Mozilla Firefox®, Google Chrome®, Safari®, or the like). Other software, hardware, and/or interfaces can be used to provide communication between the user and one or more of the device 102 and the computing device 104. As an example, the communication element 106 can request or query various files from a local source and/or a remote source. As an example, the communication element 106 can transmit data to a local or remote device such as the computing device 104.

The device 102 may be associated with a user identifier or a device identifier 108. As an example, the device identifier 108 may be any identifier, token, character, string, or the like, for differentiating one user or user device (e.g., device 102) from another user or user device. In an example, the device identifier 108 may identify a user or user device as belonging to a particular class of users or user devices. As an example, the device identifier 108 may comprise information relating to the device 102 such as a manufacturer, a model or type of device, a service provider associated with the device 102, a state of the device 102, a locator, and/or a label or classifier. Other information can be represented by the device identifier 108.

The device identifier 108 may comprise an address element 110 and a service element 112. In an example, the address element 110 can comprise or provide an internet protocol address, a network address, a media access control (MAC) address, international mobile equipment identity (IMEI) number, international portable equipment identity (IPEI) number, an Internet address, or the like. As an example, the address element 110 can be relied upon to establish a communication session between the device 102 and the computing device 104 or other devices and/or networks. As an example, the address element 110 can be used as an identifier or locator of the device 102. In an example, the address element 110 can be persistent for a particular network.

The service element 112 may comprise an identification of a service provider associated with the device 102, with the class of device 102, and/or with a particular network 105 with which the device 102 is currently accessing services associated with the service provider. The class of the device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the device 102. As an example, the service element 112 may comprise information relating to a preferred service provider for one or more particular services relating to the device 102. In an example, the address element 110 can be used to identify or retrieve data from the service element 112, or vice versa. As an example, one or more of the address element 110 and the service element 112 may be stored remotely from the device 102 and retrieved by one or more devices such as the device 102 and the computing device 104. Other information may be represented by the service element 112.

A network device 116 may be in communication with a network, such as the network 105. For example, the network device 116 may facilitate the connection of a device (e.g., device 102) to the network 105. As an example, the network device 116 may be configured as a set-top box, a gateway device, or wireless access point (WAP). In an example, the network device 116 may be configured to allow one or more wireless devices to connect to a wired and/or wireless network using Wi-Fi, Bluetooth ®, Zigbee ®, or any desired method or standard.

The network device 116 may comprise an identifier 118. As an example, the identifier 118 may be or relate to an Internet Protocol (IP) Address (e.g., IPV4/IPV6) or a media access control address (MAC address) or the like. As an example, the identifier 118 may be a unique identifier for facilitating communications on the physical network segment. In an example, the network device 116 may comprise a distinct identifier 118. As an example, the identifier 118 may be associated with a physical location of the network device 116.

The computing device 104 may comprise a server for communicating with the device 102 and/or a network device 116. As an example, the computing device 104 may communicate with the device 102 for providing data and/or services. As an example, the computing device 104 may provide services, such as network (e.g., Internet) connectivity, network printing, media management (e.g., media server), content services, streaming services, broadband services, or other network-related services. As an example, the computing device 104 may allow the device 102 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the device 102 and a database 114 for sending and receiving data therebetween. As an example, the database 114 may store a plurality of files (e.g., web pages), user identifiers or records (e.g., viewership statistics 132), or other information. As an example, the device 102 may request and/or retrieve a file from the database 114. In an example, the database 114 may store information relating to the device 102 such as the address element 110, the service element 112, and/or viewership statistics 132. As an example, the computing device 104 may obtain the device identifier 108 from the device 102 and retrieve information from the database 114 such as the address element 110, the service element 112, and/or viewership statistics 132. As an example, the computing device 104 may obtain the address element 110 from the device 102 and may retrieve the service element 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

A computing device (e.g., device 102, network device 116, computing device 104, etc.) may be configured to cause content associated with a product to output during a segment of a content item. For example, a user may request a content item to be output at the user's device (e.g., e.g., device 102, network device 116, etc.). The content item (e.g., video stream, video on demand, etc.) may comprise a plurality of segments. The computing device may determine a suitability of each segment of the content item as a candidate segment (e.g., shoppable moment segment) for outputting content associated with the product based on content, or a scene type, associated with each segment. The content, or scene type, associated with each segment may comprise one or more of an advertisement, content associated with one or more individuals that appear in the content item, text content associated with audience sentiment, a blank scene, an action scene, or a slow scene. As an example, one or more segments of the content item may be identified as candidate segments for outputting product information of products that correspond to the one or more objects that appear in the content item. For example, each segment of the plurality of segments of the content item may be scored based on the content, or scene type, associated with each segment. In an example, segments of the content item comprising advertisement breaks may receive higher scores than other segments of the content item. In another example, segments with slow scenes and/or associated with negative audience sentiment may receive lower scores than other segments associated with action scenes and/or positive audience sentiment. In another example, segments that are output right before and/or right after advertisement breaks may be excluded as candidate segments (e.g., to prevent overwhelming viewers with consecutive commerce or advertising content). The computing device may identify the highest scoring segments of the content item as the candidate segments for outputting the product information. The computing device may also identify one or more objects that are output in the content item. For example, the computing device may identify the objects that appear in each segment of the content item. The one or more objects that are identified may be compared to a product database to determine one or more products that correspond to the one or more objects. For example, the computing device may determine one or more product catalogs based on accessing inventory data (e.g., of one or more stores, websites, etc.). The computing device may determine that the one or more product catalogs include one or more products that correspond to the one or more objects output in the content item. For example, images of the one or more objects may be compared to images of the one or more products of the one or more product catalogs. In an example, a person in a scene/segment of the content item may be wearing a shirt and a jacket. The shirt and jacket may be identified and one or more products that correspond to the shirt and/or the jacket may be determined (e.g., specific brand and/or design of the shirt and/or jacket), via one or more product catalogs. The one or more products that correspond to the one or more objects may be filtered based on one or more parameters associated with each object of the one or more objects. The one or more parameters may comprise one or more of a category, a size, a duration of output, a duration since output, a decay, a sponsor vendor, or a context relevance score. As an example, the device may rank one or more products based on the filtering of the one or more products. For example, the computing device may assign each product a score based on the one or more parameters associated with each object. The computing device may associate at least one product with each segment of the one or more segments based on each product's score relative to each segment of the one or more segments. For example, each product's score may depend on a decay parameter (e.g., duration since last output, or displayed, in the content item). Based on a location of a segment in a content item (e.g., start time, middle time, or end time of when segment is displayed in the content item), a product's score may increase or decrease. For example, a product that corresponds to an object that appears at a 2 minute mark into the output/playback of the content item may have a higher score for a candidate segment (e.g., possible shoppable moment segment) that is located at 3 minutes into the output/playback of the content item than for a candidate segment that is located at 6 minutes into the output/playback of the content item. Each product may be ranked based on each product's score relative to each segment. The top ranked products (e.g., top 3, 4, 5, etc.) for a segment may be associated with the segment. The computing device may cause content associated with the top ranked products for each segment to be output (e.g., displayed) during each segment. For example, the computing device may cause content associated with a product that is associated with a first segment to output during the first segment and cause content associated with a product associated with a second segment to be output during the second segment. In an example, the content associated with each product may comprise product information. For example, the product information may comprise information on how to purchase the product (e.g., purchase details, website, store, etc.). In an example, the content associated with each product may comprise one or more of a URL, a QR code, or a UPC (universal product code). For example, the URL, the QR code, or the UPC may be displayed during the corresponding segment, wherein a user device may be used to access the URL, the QR code, or the UPC and display the product information via the user device. For example, the user device may access an image capture component (e.g., camera, IR scanner, etc.) of the user device to capture an image of, or scan, the URL, the QR code, or the UPC to access a website/webpage that provides the product information.

In an example, the device (e.g., device 102, network device 116, computing device 104, etc.) may determine (e.g., identify) one or more objects output during a segment, or scene, of a content item based on an indication associated with output of the content item. The indication may comprise user input or a tag embedded in the content item that causes output of the content item to pause. For example, a user may provide user input, or a service provider may embed one or more tags in the content item, that causes output of the content item to pause at one or more scenes. The computing device may then identify one or more objects that appear (e.g., displayed) in the paused scene/segment of the content item. For example, the device may detect the one or more objects via one or more object detection algorithms. One approach may involve using convolutional neural networks trained on large datasets of labeled images. These neural networks may be capable of detecting and classifying a wide range of objects that commonly appear in video content, such as people, clothing items, accessories, furniture, vehicles, and the like. The object detection algorithm may analyze individual frames or sequences of frames from the content item. In some cases, the algorithm may divide each frame into regions and evaluate the likelihood of objects being present in each region. The algorithm may then refine its predictions to determine the precise boundaries and classifications of detected objects.

Another technique that may be employed is feature-based object detection. This approach may involve identifying distinctive visual features of objects, such as edges, corners, or texture patterns. By matching these features to known object models, the system may recognize specific objects within the content.

In some cases, the object detection process may incorporate temporal information from video content. By tracking objects across multiple frames, the system may improve detection accuracy and maintain consistent object identification throughout the content item.

The object detection algorithm may also utilize contextual information to enhance its performance. For example, if the content item is known to be a cooking show, the algorithm may prioritize the detection of kitchen utensils, appliances, and food items.

In some cases, the system may employ multiple object detection algorithms in parallel and combine their results to improve overall accuracy. This ensemble approach may help mitigate the weaknesses of individual algorithms and provide more robust object identification.

The object detection process may output a list of identified objects for each frame or segment of the content item. This list may include information such as object type, location within the frame, size, and confidence score of the detection. By accurately identifying objects within content items, the system may enable subsequent processes such as product matching and the presentation of relevant product information to users. This object identification step may serve as a foundation for enhancing the content viewing experience with seamlessly integrated e-commerce capabilities.

In some cases, the methods and systems may match identified objects to products in catalogs through a multi-step process. The system may access inventory data from various sources to build comprehensive product catalogs. These catalogs may contain detailed information about products, including descriptions, images, pricing, and availability. When an object is identified in a content item, the system may compare the visual characteristics of the object to product images and descriptions in the catalogs. This comparison may involve analyzing features such as shape, color, texture, and size. Advanced image recognition algorithms may be employed to identify distinctive features of the object and find similar features in product catalog images.

In some cases, the system may use contextual information to refine the product matching process. For example, if the content item is a fashion show, the system may prioritize matching clothing and accessory items from relevant fashion brands. Similarly, for a home improvement show, the system may focus on matching tools and building materials.

The product matching process may also consider metadata associated with the content item. This metadata may include information about the genre, setting, or specific brands featured in the content. By leveraging this information, the system may narrow down the range of potential product matches and improve accuracy.

In some cases, the system may employ machine learning techniques to continuously improve its product matching capabilities. As the system processes more content and receives feedback on the accuracy of its matches, it may refine its matching algorithms to provide more precise results over time.

The methods and systems may also integrate with real-time inventory systems to ensure that matched products are currently available for purchase. This integration may allow the system to present users with up-to-date product information and purchasing options.

The computing device may determine at least one product of one or more products that corresponds to at least one object of the one or more objects output during the segment of the content item based on inventory data (e.g., via one or more product databases). For example, a user may provide user input selecting at least one of the objects. Based on the user input, the device may access a product database to determine the one or more products that correspond to the selected object. For example, the device may determine one or more product catalogs based on accessing the inventory data (e.g., of one or more stores, websites, etc.). The computing device may determine that the one or more product catalogs include one or more products that correspond to the selected object. For example, images of the one or more objects may be compared to images of the one or more products of the one or more product catalogs. The computing device may output content associated with the at least one product during the segment. In an example, the device may access user profile data to determine the at least one product. The device may use user preferences stored in the user profile to determine products that the user may be interested in purchasing that correspond to the selected object. As an example, the computing device may output content associated with one or more products during the segment based on the user profile data. The content associated with the product(s) may comprise one or more of a URL, a QR code, or a UPC. As an example, a user device may be used to access the URL, the QR code, or the UPC and display the product information via the user device. For example, the user device may access an image capture component (e.g., camera, IR scanner, etc.) of the user device to capture an image of, or scan, the URL, the QR code, or the UPC to access a website/webpage that provides the product information.

In an example, instead of outputting content associated with the one or more products, the computing device may access one or more images of a user viewing the content item and modify content of the content item by swapping a face of an individual wearing a product with the user's face. For example, the content item may display the individual wearing the product as if the user is the individual wearing the product.

In an example, a marketplace that correspond to the one or more objects may be generated based on the one or more products. For example, viewer product interest data may be collected for the products, wherein the marketplace may be generated based on popular products (e.g., products with the highest number of views). The system may collect viewer product interest data based on user interactions with the displayed product information. This data may include metrics such as which products users viewed, how long they engaged with product information, and whether they made purchases or saved items for later consideration. The marketplace may be displayed to the user. This marketplace may be dynamically updated as more viewer data is collected, ensuring that it reflects current trends and user preferences.

The generated marketplace may be displayed to users in various ways. In some cases, it may be accessible through a dedicated section of the content platform, allowing users to browse and purchase products featured in the content they have watched. In other cases, the marketplace may be integrated into the content viewing experience, with popular products highlighted during relevant segments of the content item.

By generating a marketplace based on viewer product interest data, the system may create a more personalized and engaging shopping experience for users. This approach may help surface products that are likely to be of interest to a broader audience, increasing user engagement and conversion rates.

The integration of these various components-from object detection and product matching to segment analysis and marketplace generation-may create a comprehensive system that enhances the content viewing experience with seamless e-commerce capabilities. This integrated approach may provide value to content creators, viewers, and product sellers by creating new opportunities for engagement and commerce within the context of content consumption.

In an example, viewers of the content item may comprise both sellers and consumers of one or more products that correspond to the one or more objects that appear in the content item. For example, viewer data (e.g., user profile data) associated with the content may be collected. A user may be determined as a seller or a buyer based on the viewer data. If the viewer is determined to be a seller, one or more of the products may be added to a product catalog. If the viewer is determined to be a buyer, the product catalog may be searched to determine product information associated with one or more of the products.

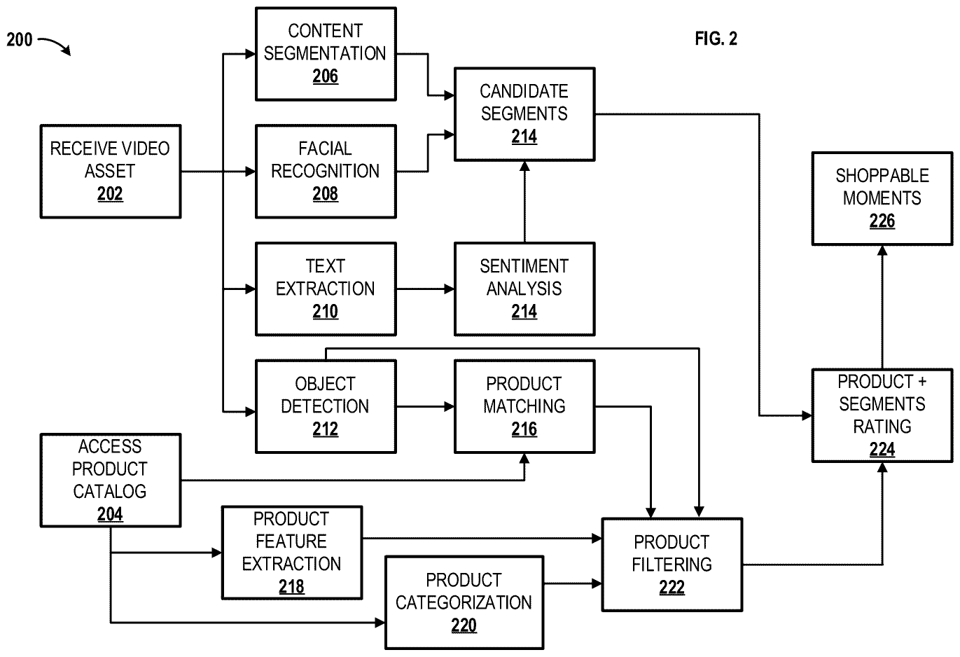

FIG. 2 shows an example process 200 for displaying product information. The process 200 may be implemented by a computing device (e.g., the device 102, the computing device 104, or the network device 116, or any combination thereof). The computing device may receive a video asset 202. For example, a user may send a request for the video asset 202, wherein the computing device may receive the video asset 202 based on the user request. The computing device may perform one or more processes on the video asset 202 in order to determine one or more candidate segments (e.g., shoppable moment segments) for providing product information associated with objects that appear in the video asset 202. The computing device may perform a content segmentation process 206 on the video asset 202. For example, the computing device may segment the video asset 202 into a plurality of segments. The computing device may perform a facial recognition process 208 on the content segment. For example, the computing device may determine one or more individuals/people in each segment of the video asset 202. For example, certain types of individuals (e.g., celebrities, actors, characters, influencers, etc.) may be detected in each segment, which may be used to score each content segment. The computing device may perform a text (e.g., closed captions) extraction process 210 on the video asset 202. For example, the computing device may extract text data (e.g., closed caption data) associated with each segment. The text data may be further processed to determine sentiment analysis. For example, the computing device may perform sentiment analysis 214 based on the text data to determine sentiment scores for each segment. For example, the text extraction 212 and sentiment analysis 214 processes may identify segments where users may be more willing to purchase products. In an example, in addition to the text-based sentiment analysis, video and/or audio content of each segment may be analyzed in order to perform audience sentiment and/or emotional analysis of each segment. For example, segments with unsettling video and/or audio content (e.g., violent, graphic, etc. scenes/segments) may be excluded as candidate segments. The results of the content segmentation 206, the facial recognition 208, and the text extraction 212 and sentiment analysis 214 processes may be used to determine candidate segments 214 of the video asset 202 for providing (e.g., displaying) product information to a user consuming (e.g., viewing) the video asset 202. For example, the results may be used to determine content (e.g., advertisement, content associated with one or more individuals, text content associated with audience sentiment, a blank scene, an action scene, a slow scene, etc.) associated with each segment of the video asset 202. The computing device may identify one or more segments of the video asset 202 as candidate segments 214 (e.g., shoppable moments segments) based on the content associated with each segment of the video asset 202. As an example, each segment of the plurality of segments of the video asset 202 may be scored based on the content associated with each segment. In an example, segments of the video asset 202 comprising advertisement breaks may receive higher scores than other segments of the video asset 202. In another example, segments with slow scenes and/or associated with negative audience sentiment may receive lower scores than other segments associated with action scenes and/or positive audience sentiment. In another example, segments that are output right before and/or right after advertisement breaks may be excluded as candidate segments (e.g., to prevent overwhelming viewers with consecutive commerce or advertising content). The computing device may identify the highest scoring segments of the video asset 202 as the candidate segments 214 for outputting the product information.

The computing device may access one or more product catalogs 204 to determine one or more products that correspond to one or more objects identified (e.g., detected) in the video asset 202. For example, the computing device may determine the one or more product catalogs 204 based on accessing inventory data (e.g., of one or more stores, websites, etc.). The computing device may perform an object detection process 212 (e.g., one or more object detection algorithms) to determine one or more objects that appear in each segment of the video asset 202. The computing device may match one or more products 216 with the identified one or more objects by comparing the one or more objects to one or more products of the one or more product catalogs 204. In addition, the computing device may perform a product feature extraction process 218 and a product categorization process 220 to determine one or more attributes of each product in the product catalogs 204. For example, the computing device may determine one or more features and one or more categories associated with each product. The results of the object detection 212, the product matching 216, the product feature extraction 218, and the product categorization 220 processes may be used to filter 222 the products that correspond to the one or more objects identified in the video asset 202. For example, the one or more products that correspond to the one or more objects may be filtered 222 based on one or more parameters associated with each object of the one or more objects. The one or more parameters may comprise one or more of a category, a size, a duration of output, a duration since output, a decay, a sponsor vendor, or a context relevance score. As an example, the computing device may rank the one or more products based on the filtering of the one or more products. For example, the device may assign each product a score based on the one or more parameters associated with each object.

The candidate segments 214 and the filtered/ranked products 222 may be analyzed to determine the products to be associated with each candidate segment 214, wherein product information associated with products associated each corresponding candidate segment 214 may be output (e.g., displayed) during each corresponding candidate segment 214. For example, the computing device may associate at least one product with each candidate segment 214 of the one or more candidate segments 214 based on each product's score relative to each candidate segment 214. For example, each product's score may depend on a decay parameter (e.g., duration since last output, or displayed, in the content item). A product's score may increase or decrease based on a location of a candidate segment 214 in the video asset 202 (e.g., start time, middle time, or end time of when a segment is displayed in the video asset 202). For example, a product that corresponds to an object that appears at a 2 minute mark into the output/playback of the video asset 202 may have a higher score for a candidate segment 214 that is located at 3 minutes into the output/playback of the video asset 202 than for a candidate segment 214 that is located at 6 minutes into the output/playback of the video asset 202. Each product may be further ranked based on each product's score relative to each candidate segment 214. The top ranked products (e.g., top 3, 4, 5, etc.) for a candidate segment 214 may be associated with the candidate segment 214.

The computing device may cause content associated with the top ranked products for each segment to be output during each segment 226. For example, the computing device may cause content associated with a product that is associated with a first segment 226 to output during the first segment 226 and cause content associated with a product associated with a second segment 226 to be output during the second segment 226. In an example, the content associated with each product may comprise product information. For example, the product information may comprise information on how to purchase the product (e.g., purchase details, website, store, etc.). In an example, the content associated with each product may comprise one or more of a URL, a QR code, or a UPC. For example, the URL, the QR code, or the UPC may be displayed during the corresponding segment, wherein a user device may be used to access the URL, the QR code, or the UPC and display the product information via the user device. For example, the user device may access an image capture component (e.g., camera, IR scanner, etc.) of the user device to capture an image, or scan, the URL, the QR code, or the UPC to access a website/webpage that provides the product information.

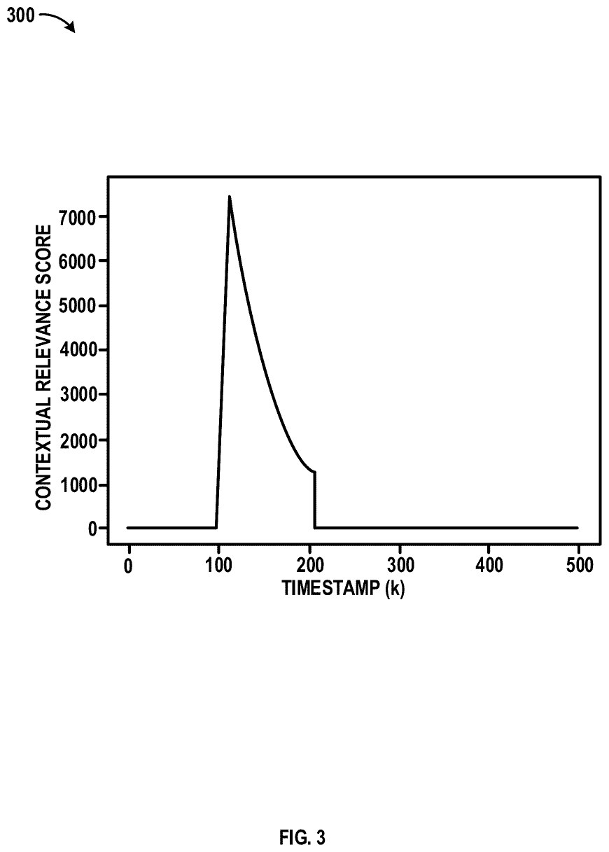

FIG. 3 shows a graph 300 of an example product relevance score. Product relevance scores may be generated for each product that corresponds to an object output in a content item. For example, a score may be calculated for each product based on one or more parameters associated with each object. The one or more parameters may comprise one or more of a category, a size, a duration of output, a duration since output, a decay, a sponsor vendor, or a context relevance score. As shown in FIG. 3, the product relevance score may increase or decrease based on a time (e.g., playback time) the corresponding object appears in the content item. For example, each product's score may depend on a decay parameter (e.g., duration since last output, or displayed, in the content item). For example, a product that corresponds to an object that appears at a 2 minute mark into the output/playback of the content item may have a higher score for a candidate segment (e.g., possible shoppable moment segment) that is located at 3 minutes into the output/playback of the content item than for a candidate segment that is located at 6 minutes into the output/playback of the content item. For example, a user may start to forget an object that appeared in the content item as time passes since the object was last displayed in the content item, wherein after a certain duration (e.g., 90 seconds, 120 seconds, 160 seconds, etc.), the object may be treated as if the user has forgotten the object's appearance in the content item. In an example, the product relevance score may be calculated based on CRSₚ(t)=CRSₚ(t−1)+Wₚ·Sizeₚ(t)·Detₚ(t)·Matₚ(t)·Priceₚ if the product is detected/matched at timestamp t, where: CRSₚ(t) is the contextual relevance score of product P at timestamp t; Wₚ is the weight set to a product's subset, wherein the weight may be set to a larger value for products from a recommended vendor that provides, or sells, one or more products; Sizeₚ(t) is the size of the product P (e.g., relative to the displayed content) shown on the screen at timestamp t; Detₚ(t) is the object detection confidence score (e.g., 0-1) at timestamp t; Matₚ(t) is the product matching score (e.g., 0-1), with the catalog, at timestamp t; Priceₚ is the price factor (e.g., 0-1 based on the value of the product) of the product P. In an example, the product relevance score may be calculated based on CRSₚ(t)=Dec(CRSₚ(t−1)) if the product is not detected/matched at timestamp t, where Dec is the decay function to reduce the CRS, emulating the reducing impression of viewers (e.g., set to 0.98=CRSₚ(t−1)) as the playback time progresses in the content item. In an example, if the product is last seen over a time period (e.g., 90 seconds, 120 seconds, 160 seconds, etc.), the function sets CRS back to zero. In an example, a group of products may have a list of CRS's that cover the duration of the content item. For example, if the content item comprises a duration of one hour, each product may have a 3600 CRS, wherein one second comprises one CRS.

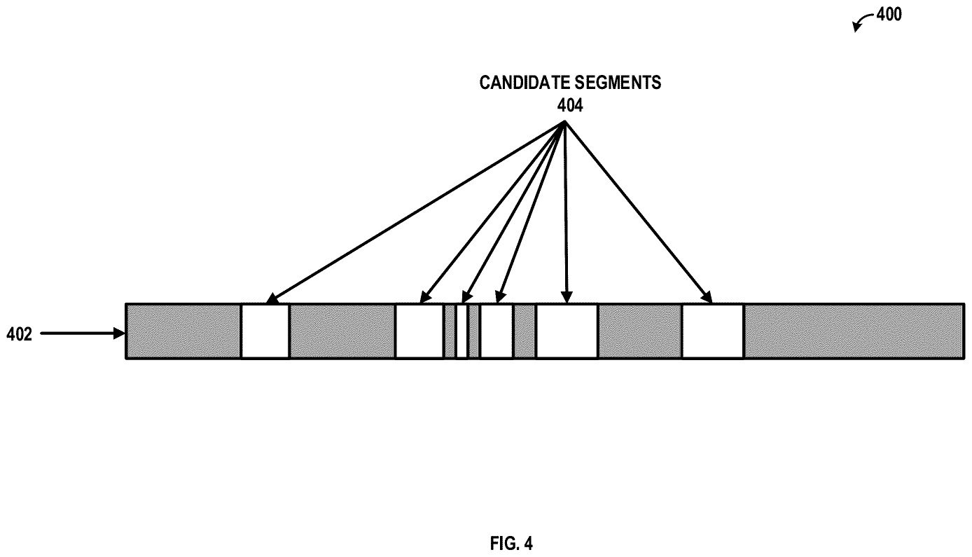

FIG. 4 shows an example of candidate segments 400 of a content item for outputting product information. A suitability of each segment of the content item as a candidate segment (e.g., shoppable moment segment) for outputting content associated with a product may be determined based on content associated with each segment. The content associated with each segment may comprise one or more of an advertisement, content associated with one or more individuals, text content associated with audience sentiment, a blank scene, an action scene, or a slow scene. As shown in FIG. 4, one or more segments 404 of the content item may be identified as candidate segments for outputting product information of products that correspond to objects that appear in the content item. For example, each segment of the plurality of segments of the content item may be scored based on the content associated with each segment (e.g., sentiment scores). For example, segment sentiment scores may be extracted based on sentiment analysis of each segment based on dialogue (e.g., between one or more individuals) associated with each segment. For example, text data (e.g., closed caption data) may be extracted from each segment and sentiment analysis may be performed on the text data to obtain sentiment scores for each segment. In an example, segments of the content item may receive lower or negative sentiment scores if the dialogue expresses failure, depression, cursing, and the like. In another example, segments of the content item may receive higher sentiment scores if the dialogue expresses happiness, cheerfulness, peaceful, kindness, and the like. In an example, if there are multiple sentiment scores associated with a sequence of dialogues within a segment, the sentiment score of the segment may be the sum aggregation of the multiple sentiment scores. In another example, segments that are output right before and/or right after advertisement breaks may be excluded as candidate segments (e.g., to prevent overwhelming viewers with consecutive commerce or advertising content). As an example, the sentiment scores may be used to identify segments where users may be more willing to purchase products. A list of candidate segments may be determined, wherein the list may be sorted based on each segment's sentiment score. The segments 404 with the highest sentiment scores may be identified as the candidate segments for outputting the product information.

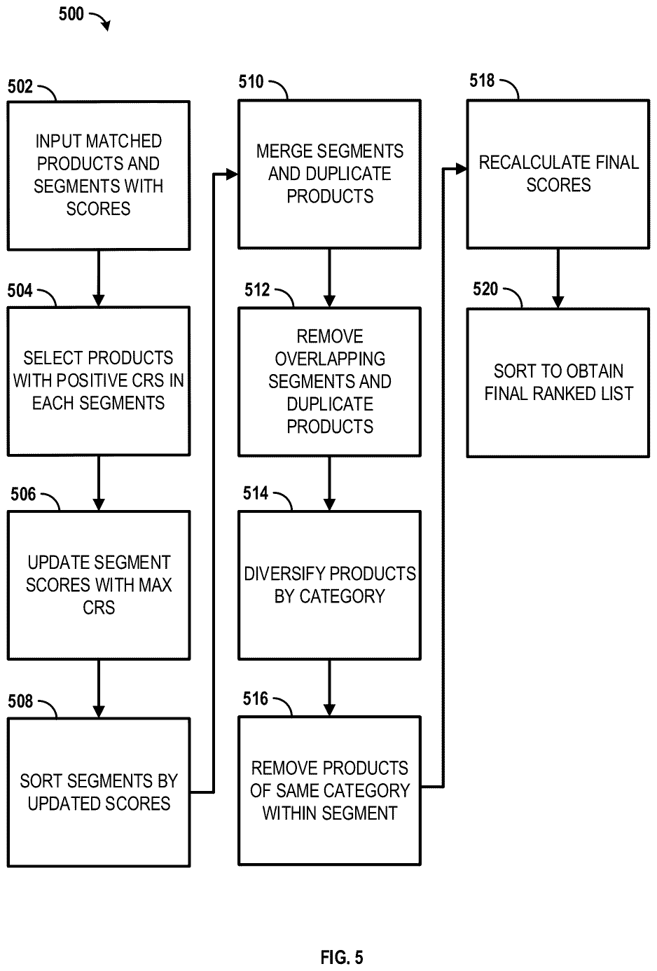

FIG. 5 shows an example process 500 for identifying a segment to display product information. The process 500 may be implemented by a computing device (e.g., the device 102, the computing device 104, or the network device 116, or any combination thereof). At 502, products that correspond to objects identified in a content item, along with the products'scores (e.g., CRS's), and a list of candidate segments, along with the candidate segments'scores, may be determined. At 504, for each candidate segment, products with positive CRS's during the corresponding segment may be determined (e.g., identified). At 506, the corresponding maximum CRS during the corresponding segment may be added to the overall segment score for that corresponding segment. At 508, the candidate segments may be sorted based on the updated segment scores (e.g., the CRS's plus the segment scores). At 510, one or more of the candidate segments may be merged with each other and one or more products associated with each candidate segment may be duplicated. At 512, overlapping candidate segments and duplicate products associated with a corresponding segment may be removed. For example, a product may be removed from a corresponding candidate segment if the product appears more than one time in a corresponding candidate segment. At 514, the products in each candidate segment may be diversified in each corresponding candidate segment by product category. As an example category taxonomy may be used to diversify the products. At 516, starting with the highest scored candidate segment and the highest ranked product, products may be further removed from the candidate segment if the products belong to the same category in the same candidate segment. This ensures that products in one candidate segment are all in different categories. At 518, the CRS's for the remaining products in each candidate may be recalculated. In addition, the recalculated CRS's may be added to the corresponding candidate segment's score. At 520, the candidate segments may be sorted again according to the updated segment scores to obtain a final list of candidate segments for providing product information.

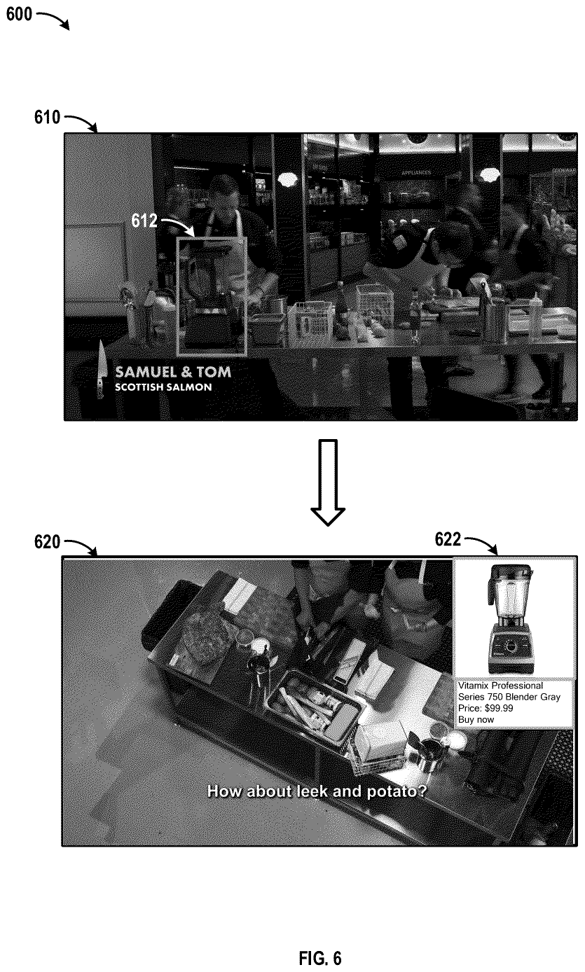

FIG. 6 shows an example scenario 600 for displaying product information. As shown in FIG. 6, an object 612 may be identified in a segment/scene 610 of a content item. A product 622 that corresponds to the object 612 may be determined. For example, the object 612 may be compared to a product database to determine the product 622 that corresponds to the object 612. For example, one or more product catalogs may be determined based on accessing inventory data (e.g., of one or more stores, websites, etc.). It may be determined that the one or more product catalogs include at least one product that corresponds to the object 612 output in the content item. Content associated with the product 622 may be output (e.g., displayed) during a candidate segment 610 (e.g., shoppable moment segment) of the content item. For example, one or more segments of the content item may be identified as candidate segments (e.g., shoppable moments segments) for outputting product information of products that correspond to objects that appear in the content item. For example, each segment of a plurality of segments of the content item may be scored based on content associated with each segment. The content associated with each segment may comprise one or more of an advertisement, content associated with one or more individuals, text content associated with audience sentiment, a blank scene, an action scene, or a slow scene. In an example, segments of the content item comprising advertisement breaks may receive higher scores than other segments of the content item. In another example, segments with slow scenes and/or associated with negative audience sentiment may receive lower scores than other segments associated with action scenes and/or positive audience sentiment. The highest scoring segments of the content item may be identified as the candidate segments for outputting the product information. The product 622 may be assigned to the candidate segment 620 based on the product's 622 score relative to the candidate segment 620. For example, a plurality of products that correspond to objects identified in the content may be scored and ranked. Each product may be assigned to a candidate segment based on each product's score relative to each segment of the one or more segments. For example, the plurality of products may be filtered and scored based on one or more parameters associated with each of the identified objects. The one or more parameters may comprise one or more of a category, a size, a duration of output, a duration since output, a decay, a sponsor vendor, or a context relevance score. As an example, each product's score may depend on a decay parameter (e.g., duration since last output, or displayed, in the content item). A product's score may increase or decrease based on a location of a candidate segment in the content item (e.g., start time, middle time, or end time of when segment is displayed in the content item). For example, a product that corresponds to an object that appears at a 2 minute mark into the output/playback of the content item may have a higher score for a candidate segment (e.g., possible shoppable moment segment) that is located at 3 minutes into the output/playback of the content item than for a candidate segment that is located at 6 minutes into the output/playback of the content item. The top ranked products (e.g., top 3, 4, 5, etc.) for a candidate segment may be associated with the segment. As shown in FIG. 6, the content associated with the product 622 may comprise product information associated with the product 622, wherein the product information may comprise information on how to purchase the product 622 (e.g., purchase details, website, store, etc.). In an example, the content associated with the product 622 may comprise one or more of a URL, a QR code, or a UPC. For example, the URL, the QR code, or the UPC may be displayed during the candidate segment 620, wherein a user device may be used to access the URL, the QR code, or the UPC and display the product information via the user device. For example, the user device may access an image capture component (e.g., camera, IR scanner, etc.) of the user device to capture an image, or scan, the URL, the QR code, or the UPC to access a website/webpage that provides the product information.

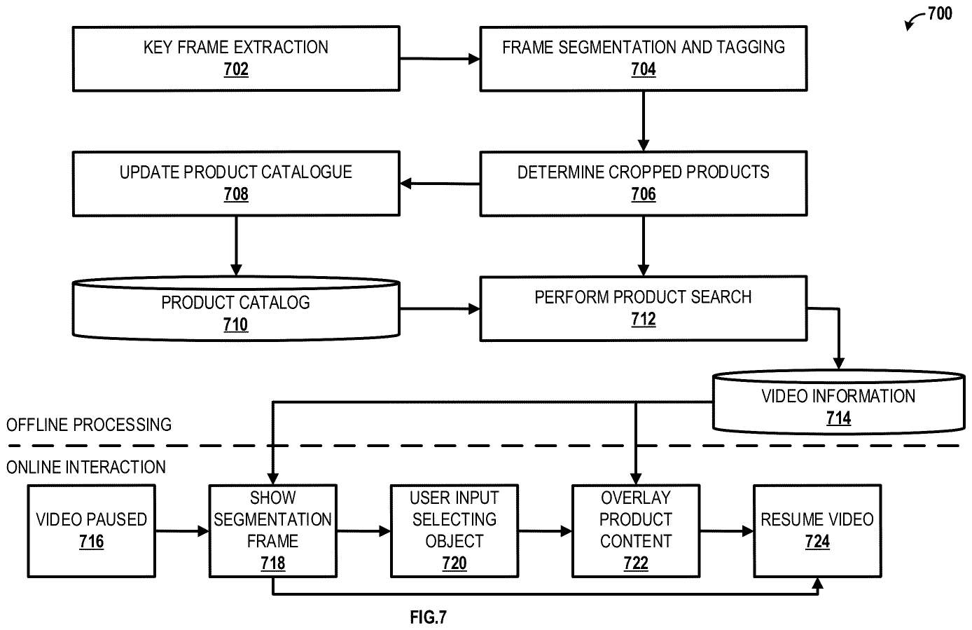

FIG. 7 shows an example product identification process 700. The process 700 may be implemented by a computing device (e.g., the device 102, the computing device 104, or the network device 116, or any combination thereof). As an example, a content item may be initially processed offline, separate from the output of the content item at a user device. For example, the content item may comprise a video file stored in a database that may be processed to determine the products that appear in the content item. At 702, one or more key frames of the content item may be extracted from the content item. Each of the key frames may be segmented and tagged with one or more objects output (e.g., displayed) in each of the corresponding key frames at 704. At 706, one or more products (e.g., clothing, jewelry, furniture, etc.) in a key frame may be cropped. For example, one or more objects in a key frame may be identified, wherein the one or more products that correspond to the one or more objects may be determined. The objects may be used to update a product catalog database at 710. At 712, a product search for the cropped products, determined at 706, may be performed based on the updated product catalog database 710. Based on the product search, one or more attributes may be extracted and stored as video information 714. For example, the one or more attributes (e.g., video information 714) may comprise a title of the content item, a time a product appears in the content item, a tag ID of a product that appears in the content item, an image URL, a product URL, a segmentation URL, etc.).

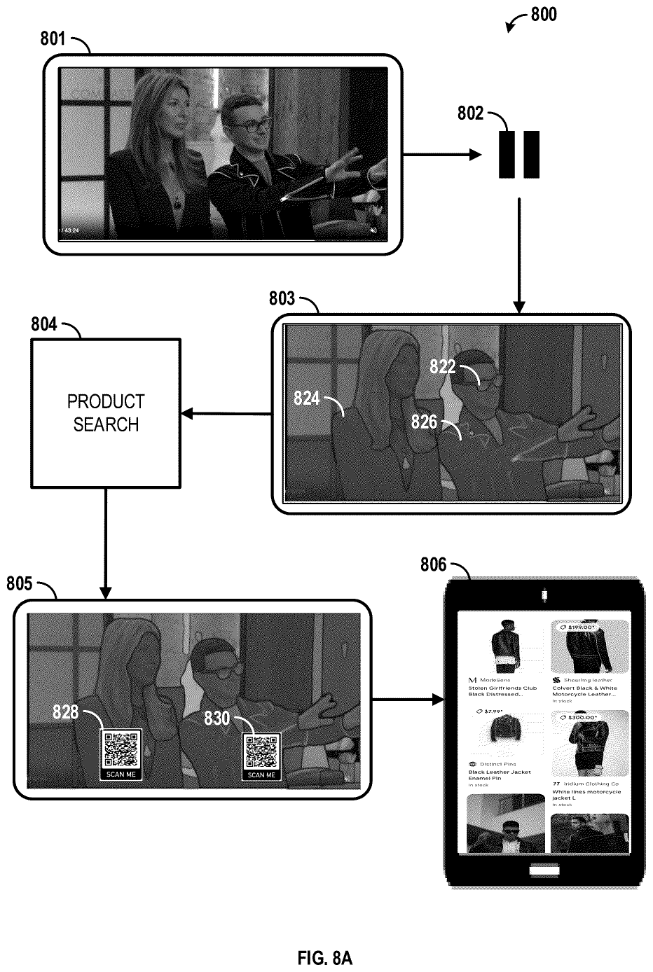

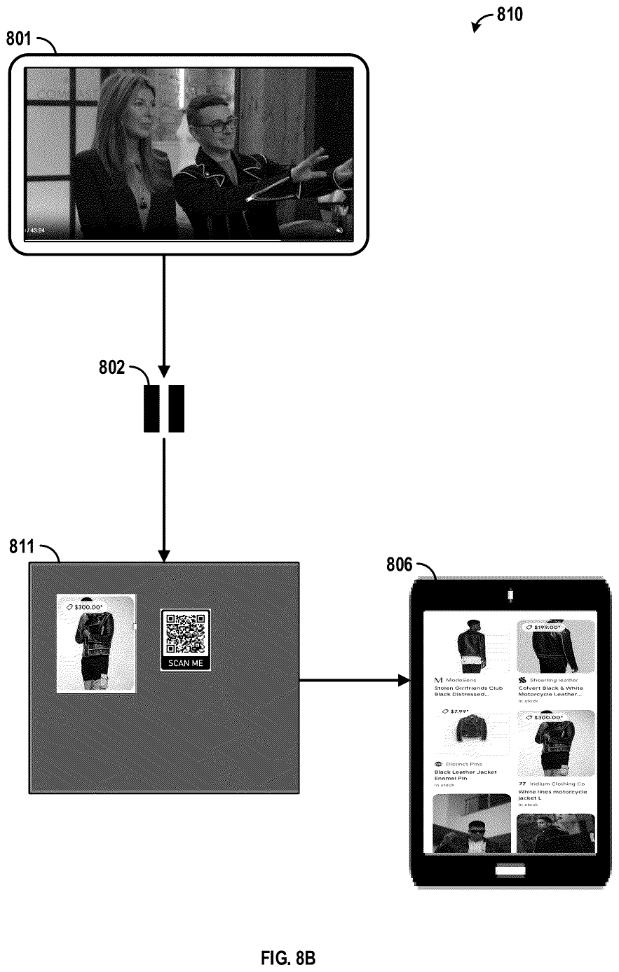

At 716, based on an indication associated with output of the content item, the user device may identify one or more objects output during a scene/frame/segment of the content item. For example, as shown in FIGS. 8A-8B, at 801, a user device may output a content item when it determines an indication associated with the output of the content item. The indication may comprise user input received from a user or a tag embedded in the content item that causes output of the content item to pause, as shown in FIGS. 8A-8B, at 802. For example, a user may provide user input, or a service provider may embed one or more tags in the content item, that causes output of the content item to pause at one or more scenes of the content item. At 718, a segmentation frame of the scene may be output (e.g., displayed). For example, the paused scene may be overlaid with one or more attributes of the video information 714 associated with the scene. For example, each object identified in the scene may be highlighted, or outlined, along with a corresponding tag ID of a product that corresponds to each object. In an example, as shown in FIG. 8A, at 803, one or more of the objects 822, 824, 826 may be identified in the scene and highlighted. At 720, a user may provide user input selecting one or more of the objects associated with corresponding products in the scene. At 724, based on the user input, content associated with the corresponding products may be overlaid on the scene. For example, as shown in FIG. 8A, at 804, the selected one or more objects identified in the scene may be compared against a product catalog to determine one or more products that correspond to the one or more objects. At 805, content 828, 830 associated with the products may be overlaid on the scene. For example, as shown in FIG. 8A, a QR code 828, 830 associated with the selected objects may be displayed in the scene. At 806, a user device may be used to access the QR code 828, 830 and display product information associated with the products via the user device. For example, the user device may access an image capture component (e.g., camera, IR scanner, etc.) of the user device to capture an image, or scan, the QR code to access a website/webpage that provides the product information of one of the products. In an example, as shown in FIG. 8B, at 811, instead of overlaying the QR code on the products in the scene, a list of the products along with each product's QR code may be displayed.

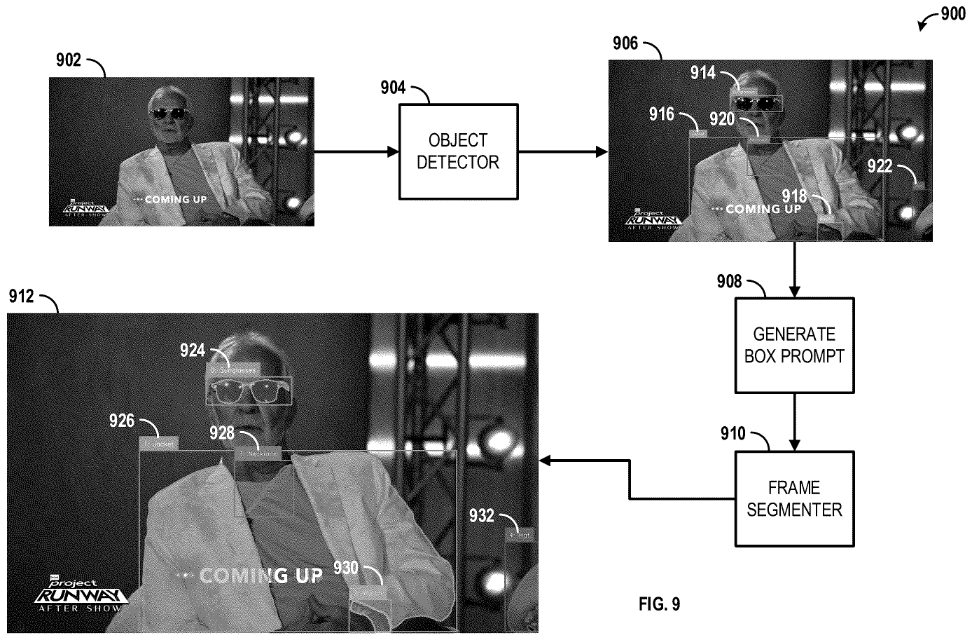

FIG. 9 shows an example frame segmentation and tagging process 900. The process 900 may be implemented by a computing device (e.g., the device 102, the computing device 104, or the network device 116, or any combination thereof). At 902, a video frame of a content item may be received. At 904, an objection detection algorithm may be performed on the video frame to identify one or more objects that appear in the frame. At 906, each object identified in the video frame may be tagged with object bounding boxes 914, 916, 918, 920, 922. At 908, a box prompt may be generated to enable receiving user input with respect to one or more of the objects output in the scene/frame/segment. For example, a user may provide input selecting one or more of the objects in order to receive product information associated with the selected objects. At 910, the video frame may be semantically segmented using a fast and efficient grounded semantic segmentation algorithm to identify the products that correspond to the objects in the scene. As an example, a grounded segmentation algorithm may be prompted with the object bounding boxes 914, 916, 918, 920, 922 as input (e.g., at 904, 906, 908) in order to increase the speed and precision of the segmentation results. At 912, the frame may be overlaid with tag ID's of the products 924, 926, 928, 930, 932 that correspond to the objects in the scene. For example, a glasses 924 product may be identified to correspond to glasses worn by an individual in the frame, a jacket 926 product may be identified to correspond to a jacket being worn by the individual in the frame, a necklace 928 product may be identified to correspond to a necklace being worn by the individual in the frame, a watch 930 product may be identified to correspond to a watch being worn by the individual in the frame, and a hat 932 product may be identified to correspond to a hat being worn by another individual in the frame.

The disclosed methods and systems provide technical improvements that enhance the functioning of computing devices. The methods and systems improve efficiency by intelligently analyzing content items to identify appropriate moments for presenting product information. This targeted approach reduces processing overhead compared to systems that indiscriminately overlay product information throughout content playback. The disclosed methods and systems may improve accuracy in product identification and relevance. By employing advanced object detection algorithms and product matching techniques, the methods and systems may more precisely identify objects within content and determine corresponding products. The filtering and ranking of products based on multiple parameters may further enhance the relevance of presented product information.

The methods and systems improve user experience by seamlessly integrating product information into content consumption. By selecting optimal segments for displaying product information and presenting it in non-disruptive formats (e.g., QR codes, URLs), the methods and systems provide shopping opportunities without significantly interrupting content playback. This integration enhances the functionality of content playback devices by adding e-commerce capabilities without compromising the primary content viewing experience. The disclosed methods and systems also improve the efficiency of network resource utilization. By selectively presenting product information during specific content segments rather than continuously throughout playback, the methods and systems reduce the amount of data that needs to be transmitted and processed. This targeted approach leads to reduced bandwidth consumption and improved overall system performance.

The methods and systems enhance the adaptability of content delivery systems. By analyzing various factors such as content type, user preferences, and viewing context, the methods and systems may dynamically adjust the presentation of product information. This adaptability may improve the relevance and effectiveness of product information delivery across different content types and viewing scenarios. The disclosed methods and systems may also improve the scalability of product recognition and information delivery in content platforms. By employing efficient algorithms for object detection, product matching, and segment analysis, the methods and systems may handle large volumes of content and product catalogs without significant performance degradation. This scalability may enhance the overall capacity and responsiveness of content delivery systems.

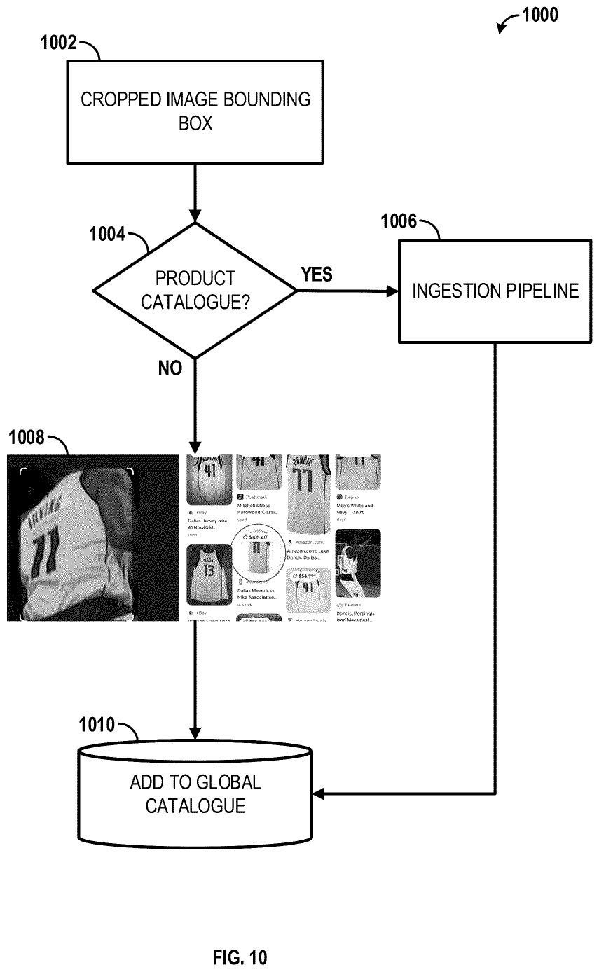

FIG. 10 shows an example process 1000 for adding products to a product catalog. The process 900 may be implemented by a computing device (e.g., the device 102, the computing device 104, or the network device 116, or any combination thereof). At 1002, a cropped image bounding box may be determined. For example, one or more objects may be identified in a content item. At 1004, it may be determined whether each of the one or more objects can be matched to at least one product of an existing product catalog. If an object is matched to at least one product in an existing product catalog, the product may be provided to an ingestion pipeline at 1006. The ingestion pipeline may subsequently add the product to a global product catalog at 1010. However, if an object is not matched to at least one product in an existing product catalog, an image search may be performed in order to match the object with one or more top product results (e.g., closest alternative products) at 1008. For example, one or more image matching algorithms (e.g., one or more machine learning models) maybe used to match the identified objects with one or more images of one or more products online. Products with images that are determined to be the closest matches to the identified objects may be determined. The identified products may be added to the global product catalog at 1010.

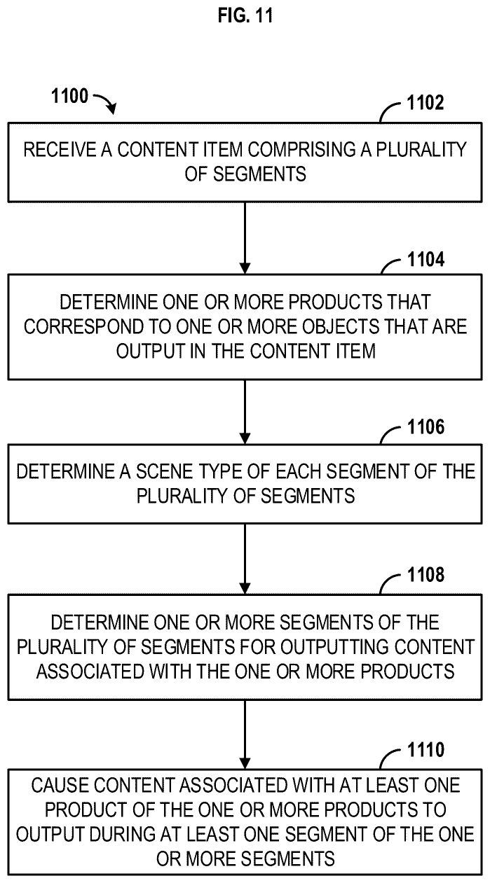

FIG. 11 shows an example method 1100 for providing product information associated with objects that appear in a content item. Method 1100 may be implemented by a computing device (e.g., the device 102, the computing device 104, or the network device 116, or any combination thereof). At step 1102, a content item comprising a plurality of segments may be received. For example, a computing device (e.g., the device 102, the computing device 104, or the network device 116, etc.) may receive the content item comprising the plurality of segments.

At step 1104, one or more products that correspond to one or more objects that are output in the content item may be determined. For example, the computing device (e.g., the device 102, the computing device 104, or the network device 116, etc.) may determine the one or more products that correspond to the one or more objects that are output in the content item. As an example, the one or more objects output in the content item may be initially identified, wherein the one or more products that correspond to the one or more objects may be determined. In an example, one or more product catalogs may be determined based on accessing inventory data. For example, the one or more objects may be compared to the one or more product catalogs to determine one or more products that correspond to the one or more objects. For example, images of the one or more objects may be compared to images of the one or more products of the one or more product catalogs. It may be determined that the one or more product catalogs include one or more products (e.g., the one or more products) that correspond to the one or more objects output in the content item. As an example, a person in a scene/segment of the content item may be wearing a shirt and a jacket. The shirt and jacket may be identified and one or more products that correspond to the shirt and/or the jacket may be determined (e.g., specific brand and/or design of the shirt and/or jacket), via one or more product catalogs.

At step 1106, a scene type of each segment of the plurality of segments may be determined. For example, the computing device (e.g., the device 102, the computing device 104, or the network device 116, etc.) may determine the scene type of each segment of the plurality of segments. The scene type may comprise one or more of an advertisement scene, a calm scene, an action scene, or a slow scene.

At step 1108, one or more segments of the plurality of segments may be determined for outputting content associated with the one or more products based on the scene type of each segment. For example, the computing device (e.g., the device 102, the computing device 104, or the network device 116, etc.) may determine the one or more segments of the plurality of segments for outputting content associated with the one or more products based on the scene type of each segment. Each segment may be scored based on the scene type of each segment in order to determine one or more candidate segments (e.g., shoppable moments segments) for outputting content associated with the one or more products. In an example, segments of the content item comprising advertisement breaks may receive higher scores than other segments of the content item. In another example, segments with slow scenes and/or associated with negative audience sentiment may receive lower scores than other segments associated with action scenes and/or positive audience sentiment. In another example, segments that are output right before and/or right after advertisement breaks may be excluded as candidate segments (e.g., to prevent overwhelming viewers with consecutive commerce or advertising content). The highest scoring segments of the content item may be identified as the candidate segments for outputting the content associated with the one or more products.

At step 1110, content associated with at least one product of the one or more products may be output during at least one segment of the one or more segments based on the one or more segments and the one or more objects. For example, the computing device (e.g., the device 102, the computing device 104, or the network device 116, etc.) may cause the content associated with the at least one product of the one or more products to output during the at least one segment of the one or more segments based on the one or more segments and the one or more objects. In an example, the content associated with the at least one product may comprise product information. For example, the product information may comprise information on how to purchase the at least one product (e.g., purchase details, website, store, etc.). In an example, the content associated with the at least one product may comprise one or more of a URL, a QR code, or a UPC (universal product code). For example, the URL, the QR code, or the UPC may be displayed during the segment, wherein a user device may be used to access the URL, the QR code, or the UPC and display the product information via the user device. For example, the user device may access an image capture component (e.g., camera, IR scanner, etc.) of the user device to capture an image of, or scan, the URL, the QR code, or the UPC to access a website/webpage that provides the product information.

As an example, the content associated with the at least one product may be output during the at least one segment based on the one or more segments and one or more parameters associated with the one or more objects. The one or more parameters may comprise one or more of a category, a size, a duration of output, a duration since output, a decay, a sponsor vendor, or a context relevance score. For example, the at least one product may be associated with the at least one segment based on the one or more segments and the one or more parameters associated with the one or more objects. As an example, the one or more products that correspond to the one or more objects may be filtered based on the one or more parameters associated with each object of the one or more objects. The at least one product may be associated with the at least one segment based on the filtering of the one or more products and based on the one or more segments. As an example, the one or more products may be ranked based on the filtering of the one or more products. For example, each product may be assigned a score based on the one or more parameters associated with each object. As an example, at least one product may be associated with each of the candidate segments based on each product's score relative to each of the candidate segments. For example, each product's score may depend on a decay parameter (e.g., duration since last output, or displayed, in the content item). A product's score may increase or decrease based on a location of a candidate segment in the content item (e.g., start time, middle time, or end time of when segment is displayed in the content item). For example, a product that corresponds to an object that appears at a 2 minute mark into the output/playback of the content item may have a higher score for a candidate segment that is located at 3 minutes into the output/playback of the content item than for a candidate segment that is located 6 minutes into the output/playback of the content item. Each product may be ranked based on each product's score relative to each segment. The top ranked products (e.g., top 1, 3, 4, etc.) for a segment may be associated with the segment.

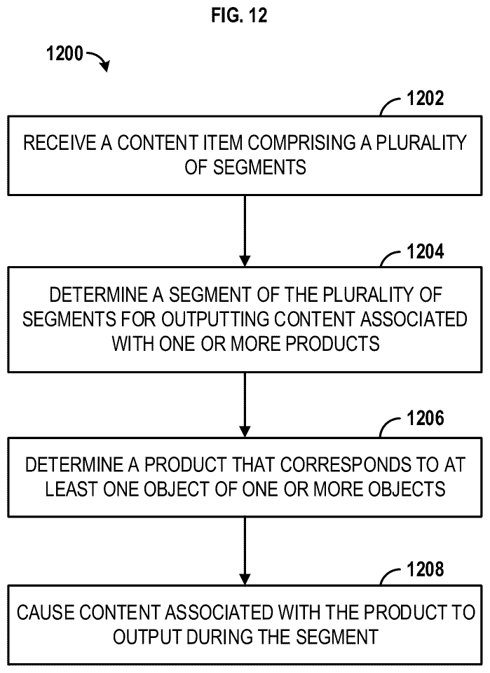

FIG. 12 shows an example method 1200 for providing product information associated with objects that appear in a content item. Method 1200 may be implemented by a computing device (e.g., the device 102, the computing device 104, or the network device 116, or any combination thereof). At step 1202, a content item comprising a plurality of segments may be received. For example, a computing device (e.g., the device 102, the computing device 104, or the network device 116, etc.) may receive the content item. One or more objects may be output in the content item. For example, the computing device may identify the one or more objects output in the content item.

At step 1204, a segment of the plurality of segments may be determined for outputting content associated with one or more products based on content associated with each segment of the plurality of segments. For example, the computing device (e.g., the device 102, the computing device 104, or the network device 116, etc.) may determine the segment of the plurality of segments for outputting content associated with the one or more products based on the content associated with each segment of the plurality of segments. The content associated with each segment may comprise one or more of an advertisement, content associated with one or more individuals, text content associated with audience sentiment, a blank scene, an action scene, or a slow scene. As an example, each segment may be scored based on the content associated with each segment in order to determine one or more candidate segments (e.g., shoppable moments segments) for outputting content associated with one or more products. In an example, segments of the content item comprising advertisement breaks may receive higher scores than other segments of the content item. In another example, segments with slow scenes and/or associated with negative audience sentiment may receive lower scores than other segments associated with action scenes and/or positive audience sentiment. In another example, segments that are output right before and/or right after advertisement breaks may be excluded as candidate segments (e.g., to prevent overwhelming viewers with consecutive commerce or advertising content). The highest scoring segments of the content item may be identified as the candidate segments for outputting the product information. As an example, the one or more objects may be output in the content item prior to the segment.

At step 1206, a product that corresponds to at least one object of the one or more objects may be determined based on a duration of time between an output time of each object of the one or more objects in the content item and an output time of the segment in the content item. For example, the computing device (e.g., the device 102, the computing device 104, or the network device 116, etc.) may determine the product that corresponds to the at least one object of the one or more objects based on the duration of time between the output time of each object of the one or more objects in the content item and the output time of the segment in the content item. As an example, the product may be determined based on one or more parameters associated with the one or more objects and based on the segment. The one or more parameters may comprise one or more of a category, a size, a duration of output, a duration since output, a decay, a sponsor vendor, or a context relevance score. For example, one or more products that correspond to the one or more objects may be filtered based on the one or more parameters associated with each object of the one or more objects. The product may be associated with the segment based on filtering the one or more products and based on the segment. As an example, the one or more products may be ranked based on the filtering of the one or more products. For example, each product may be assigned a score based on the one or more parameters associated with each object. As an example, at least one product may be associated with each of the candidate segments based on each product's score relative to each of the candidate segments. For example, each product's score may depend on a decay parameter (e.g., duration since last output, or displayed, in the content item). A product's score may increase or decrease based on a location of a candidate segment in the content item (e.g., start time, middle time, or end time of when segment is displayed in the content item). For example, a product that corresponds to an object that appears at a 2 minute mark into the output/playback of the content item may have a higher score for a candidate segment that is located at 3 minutes into the output/playback of the content item than for a candidate segment that is located 6 minutes into the output/playback of the content item. Each product may be ranked based on each product's score relative to each segment. The top ranked products (e.g., top 1, 3, 4, etc.) for a segment may be associated with the segment.

At step 1208, content associated with the product may be output during the segment. For example, the computing device (e.g., the device 102, the computing device 104, or the network device 116, etc.) may cause the content associated with the product to output during the segment. In an example, the content associated with the product may comprise product information. For example, the product information may comprise information on how to purchase the at least one product (e.g., purchase details, website, store, etc.). In an example, the content associated with the at least one product may comprise one or more of a URL, a QR code, or a UPC (universal product code). For example, the URL, the QR code, or the UPC may be displayed during the segment, wherein a user device may be used to access the URL, the QR code, or the UPC and display the product information via the user device. For example, the user device may access an image capture component (e.g., camera, IR scanner, etc.) of the user device to capture an image of, or scan, the URL, the QR code, or the UPC to access a website/webpage that provides the product information.

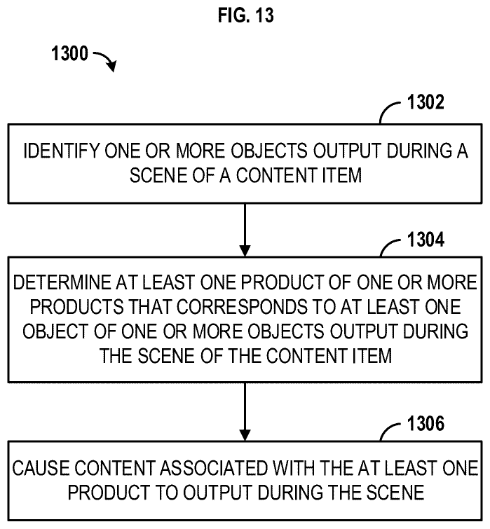

FIG. 13 shows an example method 1300 for providing product information associated with objects that appear in a content item. Method 1300 may be implemented by a computing device (e.g., the device 102, the computing device 104, or the network device 116, or any combination thereof). At step 1302, one or more objects output during a scene of the content item may be identified based on an indication that causes output of the content item to pause at the scene of the content item. For example, a computing device (e.g., the device 102, the computing device 104, or the network device 116, etc.) may identify the one or more objects output during the scene of the content item based on the indication that causes output of the content item to pause at the scene of the content item. The indication may comprise user input or a tag embedded in the content item. For example, a user may provide user input, or a service provider may embed one or more tags in the content item, that causes output of the content item to pause at one or more scenes. The device may then identify one or more objects that appear (e.g., displayed) in the paused scene/segment of the content item.

At step 1304, at least one product of one or more products that corresponds to at least one object of the one or more objects output during the scene of the content item may be determined based on inventory data. For example, the computing device (e.g., the device 102, the computing device 104, or the network device 116, etc.) may determine the at least one product of the one or more products that corresponds to the at least one object of the one or more objects output during the scene of the content item based on the inventory data. As an example, a user may provide user input selecting at least one of the objects. Based on the user input, a product database may be accessed to determine the at least one product that correspond to the selected object. For example, the computing device may determine one or more product catalogs based on accessing the inventory data (e.g., of one or more stores, websites, etc.). It may be determined that the one or more product catalogs include one or more products that correspond to the one or more objects output in the content item. In an example, user profile data may be accessed to determine the at least one product. For example, user preferences stored in the user profile may be used to determine products that a user may be interested in purchasing that correspond to the one or more objects. For example, the at least one product of the one or more products that corresponds to the at least one object of the one or more objects output in the content item may be determined based on the user profile data associated with a user device and based on the inventory data.

At step 1306, product information associated with the at least one product may be output based on content associated with the at least one product output during the scene. For example, the computing device (e.g., the device 102, the computing device 104, or the network device 116, etc.) may cause output of the product information associated with the at least one product based on the content associated with the at least one product output during the scene. The content associated with the at least one product may comprise one or more of a URL, a QR code, or a UPC. For example, the URL, the QR code, or the UPC may be displayed during the segment, wherein a user device may be used to access the URL, the QR code, or the UPC and display the product information via the user device. For example, the user device may access an image capture component (e.g., camera, IR scanner, etc.) of the user device to capture an image of, or scan, the URL, the QR code, or the UPC to access a website/webpage that provides the product information.

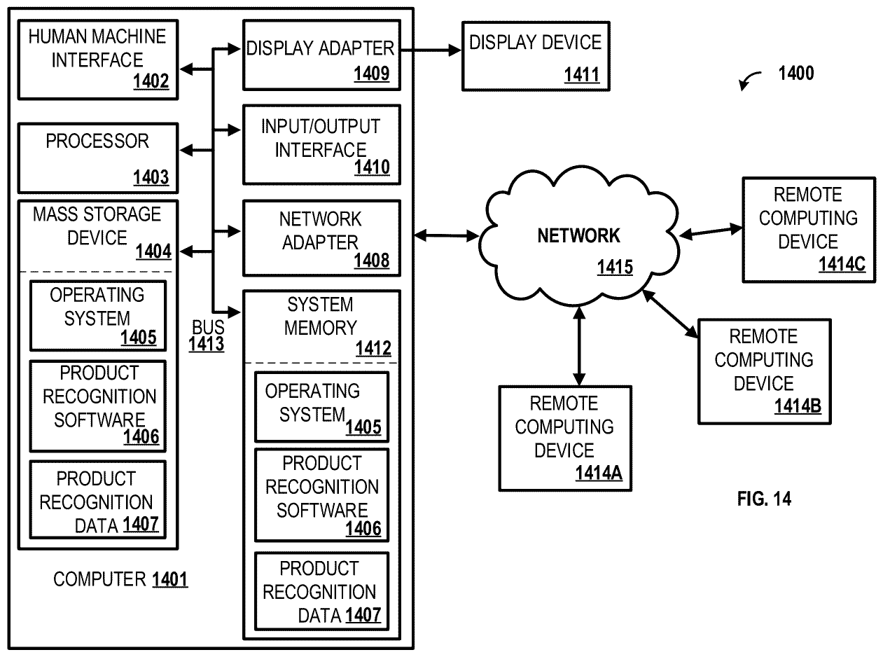

The methods and systems can be implemented on a computer 1401 as illustrated in FIG. 14 and described below. By way of example, computing device 104, device 102, and/or the network device 116 of FIG. 1 can be a computer 1401 as illustrated in FIG. 14.

Similarly, the methods and systems disclosed can utilize one or more computers to perform one or more functions in one or more locations. FIG. 14 is a block diagram illustrating an example operating environment 1400 for performing the disclosed methods. This example operating environment 1400 is only an example of an operating environment and is not intended to suggest any limitation as to the scope of use or functionality of operating environment architecture. Neither should the operating environment 1400 be interpreted as having any dependency or requirement relating to any one or combination of components illustrated in the example operating environment 1400.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1401. The computer 1401 can comprise one or more components, such as one or more processors 1403, a system memory 1412, and a bus 1413 that couples various components of the computer 1401 comprising the one or more processors 1403 to the system memory 1412. The system can utilize parallel computing.

The bus 1413 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1413, and all buses specified in this description can also be implemented over a wired or wireless network connection and one or more of the components of the computer 1401, such as the one or more processors 1403, a mass storage device 1404, an operating system 1405, product recognition software 1406, product recognition data 1407, a network adapter 1408, the system memory 1412, an Input/Output Interface 1410, a display adapter 1409, a display device 1411, and a human machine interface 1402, can be contained within one or more remote computing devices 1414A-1414C at physically separate locations, connected through buses of this form, in effect implementing a fully distributed system.

The computer 1401 typically comprises a variety of computer readable media.

Examples of readable media can be any available media that is accessible by the computer 1401 and comprises, for example and not meant to be limiting, both volatile and non-volatile media, removable and non-removable media. The system memory 1412 can comprise computer readable media in the form of volatile memory, such as random access memory (RAM), and/or non-volatile memory, such as read only memory (ROM). The system memory 1412 typically can comprise data such as the product recognition data 1407 and/or program modules such as the operating system 1405 and the product recognition software 1406 that are accessible to and/or are operated on by the one or more processors 1403.

In another aspect, the computer 1401 can also comprise other removable/non-removable, volatile/non-volatile computer storage media. The mass storage device 1404 can provide non-volatile storage of computer code, computer readable instructions, data structures, program modules, and other data for the computer 1401. For example, the mass storage device 1404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1404, such as, by way of example, the operating system 1405 and the product recognition software 1406. One or more of the operating system 1405 and the product recognition software 1406 (or some combination thereof) can comprise elements of the programming and the product recognition software 1406. The product recognition data 1407 can also be stored on the mass storage device 1404. The product recognition data 1407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1415.

In another aspect, the user can enter commands and information into the computer 1401 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1403 via the human machine interface 1402 that is coupled to the bus 1413, but can be connected by other interface and bus structures, such as a parallel port, game port, an IEEE 1394 Port (also known as a Firewire port), a serial port, a network adapter 1408, and/or a universal serial bus (USB).

In yet another aspect, the display device 1411 can also be connected to the bus 1413 via an interface, such as the display adapter 1409. It is contemplated that the computer 1401 can have more than one display adapter 1409 and the computer 1401 can have more than one display device 1411. For example, the display device 1511 can be a monitor, an LCD (Liquid Crystal Display), light emitting diode (LED) display, television, smart lens, smart glass, and/or a projector. In addition to the display device 1411, other output peripheral devices can comprise components such as speakers (not shown) and a printer (not shown) which can be connected to the computer 1401 via an Input/Output Interface 1410. Any step and/or result of the methods can be output in any form to an output device. Such output can be any form of visual representation, comprising, but not limited to, textual, graphical, animation, audio, tactile, and the like. The display device 1411 and the computer 1401 can be part of one device, or separate devices.

The computer 1401 can operate in a networked environment using logical connections to one or more remote computing devices 1414A-1414C. By way of example, a remote computing device 1414A-1414C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1401 and a remote computing device 1414A-1414C can be made via a network 1415, such as a local area network (LAN) and/or a general wide area network (WAN). Such network connections can be through the network adapter 1408. The network adapter 1408 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1405 are illustrated herein as discrete blocks, although it is recognized that such programs and components can reside at various times in different storage components of the computing device 1401, and are executed by the one or more processors 1403 of the computer 1401. An implementation of the product recognition software 1406 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

1. A method comprising:
receiving, by a computing device, a content item comprising a plurality of segments;
determining one or more products that correspond to one or more objects that are output in the content item;
determining a scene type of each segment of the plurality of segments;
determining, based on the scene type of each segment, one or more segments of the plurality of segments for outputting content associated with the one or more products; and
causing, based on the one or more segments and the one or more objects, content associated with at least one product of the one or more products to output during at least one segment of the one or more segments.

2. The method of claim 1, wherein determining the one or more products that correspond to the one or more objects that are output in the content item comprises:
determining, based on accessing inventory data, one or more product catalogs; and
determining that the one or more product catalogs include one or more products that correspond to the one or more objects that are output in the content item.

3. The method of claim 1, wherein the scene type comprises one or more of an advertisement scene, a calm scene, an action scene, or a slow scene.

4. The method of claim 1, wherein causing, based on the one or more segments and the one or more objects, content associated with the at least one product of the one or more products to be output during the at least one segment of the one or more segments comprises:
causing, based on the one or more segments and one or more parameters associated the one or more objects, content associated with the at least one product of the one or more products to be output during the at least one segment of the one or more segments.

5. The method of claim 4, wherein the one or more parameters comprise one or more of a category, a size, a duration of output, a duration since output, a decay, a sponsor vendor, or a context relevance score.

6. The method of claim 1, wherein the content associated with the at least one product comprises product information.

7. The method of claim 1, wherein the content associated with the at least one product comprises one or more of a URL or a QR code, wherein a second device outputs product information associated with the at least one product based on accessing the URL or the QR code.

8. An apparatus comprising:
one or more processors; and
a memory storing processor-executable instructions that, when executed by the one or more processors, cause the apparatus to:
receive a content item comprising a plurality of segments;
determine one or more products that correspond to one or more objects that are output in the content item;
determine each segment of the plurality of segments comprises a scene type;
determine, based on the scene type of each segment, one or more segments of the plurality of segments for outputting content associated with the one or more products; and
cause, based on the one or more segments and the one or more objects, content associated with at least one product of the one or more products to output during at least one segment of the one or more segments.

9. The apparatus of claim 8, wherein the processor-executable instructions that, when executed by the one or more processors, cause the apparatus to determine the one or more products that correspond to the one or more objects that are output in the content item, further cause the apparatus to:
determine, based on accessing inventory data, one or more product catalogs; and
determine that the one or more product catalogs include one or more products that correspond to the one or more objects that are output in the content item.

10. The apparatus of claim 8, wherein the scene type comprises one or more of an advertisement scene, a calm scene, an action scene, or a slow scene.

11. The apparatus of claim 8, wherein the processor-executable instructions that, when executed by the one or more processors, cause the apparatus to cause, based on the one or more segments and the one or more objects, content associated with the at least one product of the one or more products to be output during the at least one segment of the one or more segments, further case the apparatus to:
cause, based on the one or more segments and one or more parameters associated the one or more objects, content associated with the at least one product of the one or more products to be output during the at least one segment of the one or more segments.

12. The apparatus of claim 11, wherein the one or more parameters comprise one or more of a category, a size, a duration of output, a duration since output, a decay, a sponsor vendor, or a context relevance score.

13. The apparatus of claim 8, wherein the content associated with the at least one product comprises product information.

14. The apparatus of claim 8, wherein the content associated with the at least one product comprises one or more of a URL or a QR code, wherein a second device outputs product information associated with the at least one product based on accessing the URL or the QR code.

15. One or more non-transitory computer-readable media storing processor-executable instructions that, when executed by at least one processor, cause the at least one processor to:
receive, by a computing device, a content item comprising a plurality of segments;
determine one or more products that correspond to one or more objects that are output in the content item;
determine each segment of the plurality of segments comprises a scene type;
determine, based on the scene type of each segment, one or more segments of the plurality of segments for outputting content associated with the one or more products; and
cause, based on the one or more segments and the one or more objects, content associated with at least one product of the one or more products to output during at least one segment of the one or more segments.

16. The non-transitory computer-readable media of claim 15, wherein the processor-executable instructions that, when executed by the at least one processor, cause the at least one processor to determine the one or more products that correspond to the one or more objects that are output in the content item, further cause the at least one processor to:
determine, based on accessing inventory data, one or more product catalogs; and
determine that the one or more product catalogs include one or more products that correspond to the one or more objects that are output in the content item.

17. The non-transitory computer-readable media of claim 15, wherein the scene type comprises one or more of an advertisement scene, a calm scene, an action scene, or a slow scene.

18. The non-transitory computer-readable media of claim 15, wherein the processor-executable instructions that, when executed by the at least one processor, cause the at least one processor to cause, based on the one or more segments and the one or more objects, content associated with the at least one product of the one or more products to be output during the at least one segment of the one or more segments, further case the at least one processor to:
cause, based on the one or more segments and one or more parameters associated the one or more objects, content associated with the at least one product of the one or more products to be output during the at least one segment of the one or more segments.

19. The non-transitory computer-readable media of claim 18, wherein the one or more parameters comprise one or more of a category, a size, a duration of output, a duration since output, a decay, a sponsor vendor, or a context relevance score.

20. The non-transitory computer-readable media of claim 15, wherein the content associated with the at least one product comprises product information.

21. The non-transitory computer-readable media of claim 15, wherein the content associated with the at least one product comprises one or more of a URL or a QR code, wherein a second device outputs product information associated with the at least one product based on accessing the URL or the QR code.

22. A system comprising:
a first computing device configured to send a content item comprising a plurality of segments; and
a second computing device configured to:
receive the content item,
determine one or more products that correspond to one or more objects that are output in the content item,
determine each segment of the plurality of segments comprises a scene type,
determine, based on the scene type of each segment, one or more segments of the plurality of segments for outputting content associated with the one or more products, and
cause, based on the one or more segments and the one or more objects, content associated with at least one product of the one or more products to output during at least one segment of the one or more segments.

23. The system of claim 22, wherein the second computing device is configured to determine the one or more products that correspond to the one or more objects that are output in the content item, the second computing device is further configured to:
determine, based on accessing inventory data, one or more product catalogs; and
determine that the one or more product catalogs include one or more products that correspond to the one or more objects that are output in the content item.

24. The system of claim 22, wherein the scene type comprises one or more of an advertisement scene, a calm scene, an action scene, or a slow scene.

25. The system of claim 22, wherein the second computing device is configured to cause, based on the one or more segments and the one or more objects, content associated with the at least one product of the one or more products to be output during the at least one segment of the one or more segments, the second computing device is further configured to:
cause, based on the one or more segments and one or more parameters associated the one or more objects, content associated with the at least one product of the one or more products to be output during the at least one segment of the one or more segments.

26. The system of claim 25, wherein the one or more parameters comprise one or more of a category, a size, a duration of output, a duration since output, a decay, a sponsor vendor, or a context relevance score.

27. The system of claim 22, wherein the content associated with the at least one product comprises product information.

28. The system of claim 22, wherein the content associated with the at least one product comprises one or more of a URL or a QR code, wherein a second device outputs product information associated with the at least one product based on accessing the URL or the QR code.
